(19) United States
(12) Patent Application Publication
(10) Pub. No.: US 2026/0034732 A1
(43) Pub. Date: Feb. 5, 2026

(54) THREE DIMENSIONAL MOLDING DEVICE AND A METHOD FOR MANUFACTURING A THREE DIMENSIONAL MOLDED OBJECT

(71) Applicant: SEIKO EPSON CORPORATION, Tokyo (JP)

(72) Inventors: Yasushi KUTSUWADA, MATSUMOTO-SHI (JP); Kazuhide NAKAMURA, ASAHI-MURA (JP)

(21) Appl. No.: 19/282,608

(22) Filed: Jul. 28, 2025

(30) Foreign Application Priority Data
Jul. 30, 2024 (JP) 2024-123145

(51) Int. Cl. B29C 64/321; B29C 64/393; B33Y 10/00; B33Y 30/00; B33Y 40/10; B33Y 50/02

(52) U.S. Cl. CPC B29C 64/321; B29C 64/393; B33Y 10/00; B33Y 30/00; B33Y 40/10; B33Y 50/02

(57) ABSTRACT

A three dimensional molding device includes a plasticization section that generates a molding material, a nozzle that ejects the molding material toward a stage, and a control section that controls molding of a three dimensional molded object using the molding material. The plasticization section includes a drive motor, a screw, a barrel, a heating section, and a position change mechanism configured to change a relative position between the screw and the barrel. The control section, when a condition related to molding is a first condition, sets a distance between the screw and the barrel to a first distance to cause the plasticization section to generate the molding material, and, when the condition is a second condition, sets the distance between the screw and the barrel to a second distance to cause the plasticization section to generate the molding material. The second distance is greater than the first distance.

The present application is based on, and claims priority from JP Application Serial Number 2024-123145, filed July 30,2024, the disclosure of which is hereby incorporated by reference herein in its entirety.

### BACKGROUND

### 1. Technical Field

The present disclosure relates to a three dimensional molding device and a method for manufacturing a three dimensional molded object.

### 2. Related Art

JP-A-2000-82588 discloses a three dimensional molding device in which the ejection amount of a molding material is controlled according to the nozzle movement speed.

There is room for improvement in at least one of high accuracy and high speed in molding of a three dimensional molded object.

### SUMMARY

According to a first aspect of the present disclosure, a three dimensional molding device is provided. This three dimensional molding device includes a plasticization section that plasticizes a material to generate a molding material; a nozzle that ejects the molding material toward a stage; and a control section that controls molding of a three dimensional molded object by ejecting the molding material from the nozzle, wherein the plasticization section includes a drive motor, a screw that is rotated by the drive motor and has a groove forming surface in which a protruding stripe section is formed from a central section toward an outer periphery, a barrel that faces the groove forming surface and that has a communicating hole communicating with the nozzle at a position facing the central section of the groove forming surface, a heating section configured to heat the material supplied between the screw and the barrel, and a position change mechanism configured to change a relative position between the screw and the barrel, the control section when a condition related to molding is a first condition, sets a distance between the screw and the barrel to a first distance by using the position change mechanism and causes the plasticization section to generate the molding material and when the condition is a second condition, sets the distance between the screw and the barrel to a second distance by using the position change mechanism and causes the plasticization section to generate the molding material, and the second distance is greater than the first distance.

According to a second aspect of the present disclosure, there is provided a three dimensional molded object manufacturing method. This manufacturing method includes a generation step of generating a molding material by plasticizing a material by a plasticization section and a molding step of molding a three dimensional molded object by ejecting the molding material from a nozzle, wherein the plasticization section includes a drive motor, a screw that is rotated by the drive motor and that has a groove forming surface in which a protruding stripe section is formed from a central section toward an outer periphery, a barrel that faces the groove forming surface and that has a communicating hole communicating with the nozzle at a position facing the central section of the groove forming surface, a heating section configured to heat the material supplied between the screw and the barrel, and a position change mechanism configured to change a relative position between the screw and the barrel, in the generation step when a condition related to molding is a first condition, sets a distance between the screw and the barrel to a first distance by using the position change mechanism and causes the plasticization section to generate the molding material and when the condition is a second condition, sets the distance between the screw and the barrel to a second distance by using the position change mechanism and causes the plasticization section to generate the molding material, and the second distance is greater than the first distance.

### BRIEF DESCRIPTION OF THE DRAWINGS

FIG. 1 is a diagram illustrating schematic configuration of a three dimensional molding device.

FIG. 2 is a cross-sectional view illustrating schematic configuration of a plasticization section.

FIG. 3 is a perspective view showing schematic configuration of a screw.

FIG. 4 is a top view of a barrel.

FIG. 5 is a diagram illustrating an example of material used in molding of a three dimensional molded object.

FIG. 6 is a flowchart of a three dimensional molding process.

### DESCRIPTION OF EMBODIMENTS

### A. First Embodiment

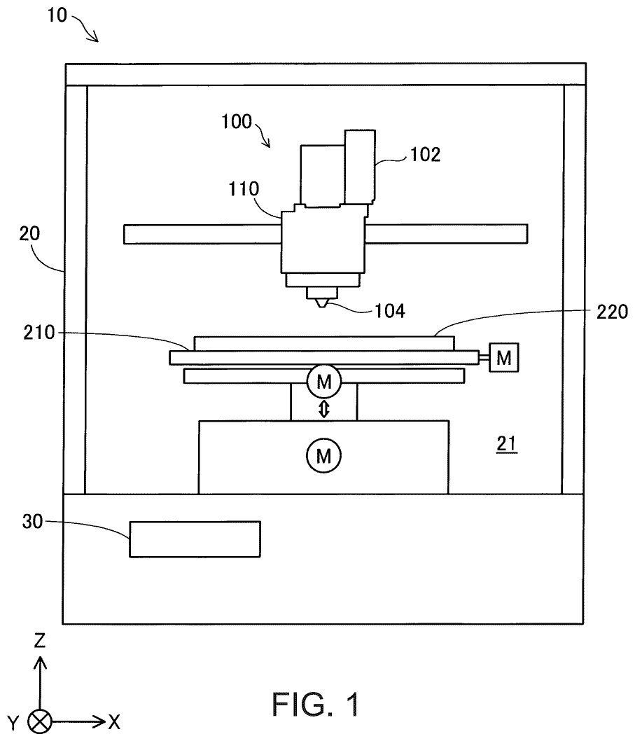

FIG. 1 is a diagram illustrating schematic configuration of a three dimensional molding device 10 according to a first embodiment. In FIG. 1, arrows are shown along X, Y, and Z directions orthogonal to each other. The X, Y, and Z directions in FIG. 1 and the X, Y, and Z directions in other drawings represent the same directions. Hereinafter, the +Z direction is referred to as “up”, and the −Z direction is referred to as “down”.

The three dimensional molding device 10 includes a ejection section 100, a movement mechanism section 210, a stage 220, a chamber 20, and a control section 30.

The ejection section 100 includes a plasticization section 110, a material storage section 102, and a nozzle 104. The material storage section 102 is, for example, a hopper. In the present embodiment, resin in pellet form is stored in the material storage section 102 as material. The material may be pressure-fed from the outside to the material storage section 102 via a tube. The plasticization section 110 generates the molding material by plasticizing at least a part of the material supplied from the material storage section 102. The molding material generated by the plasticization section 110 is supplied to the nozzle 104 and is ejected from the nozzle 104 toward the molding surface located on the upper surface of the stage 220. In the present embodiment, “plasticization” means a concept including melting, and means a change from a solid state to a fluid state. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point.

The movement mechanism section 210 changes the relative position between the ejection section 100 and the stage 220. In the present embodiment, the movement mechanism section 210 moves the stage 220 with respect to the ejection section 100. The movement mechanism section 210 in the present embodiment is configured by a three axis positioner that moves the stage 220 in three axial directions of the X, Y, and Z directions by driving forces of three motors. Each motor is driven under the control of the control section 30. Note that in other embodiments, the movement mechanism section 210 does not have to be configured to move the stage 220, and may be configured to move the ejection section 100 without moving the stage 220, for example. The movement mechanism section 210 may be configured to move both the stage 220 and the ejection section 100.

The chamber 20 has a molding space 21 therein. The ejection section 100, the movement mechanism section 210, and the stage 220 are accommodated in the molding space 21. The chamber 20 may include a heater for heating the molding space 21.

The control section 30 is configured by a computer including one or more processors, a storage device, and an input/output interface that inputs and outputs signals to and from the outside. The processor executes a program or a command stored in the storage device, and thus the control section 30 controls the plasticization section 110 and the movement mechanism section 210. The control section 30 controls the plasticization section 110 to eject the molding material while controlling the movement mechanism section 210 to move the stage 220, thereby laminating a plurality of layers on the stage 220 to mold a three dimensional molded object. The control section 30 may be configured by a combination of a plurality of circuits instead of the computer.

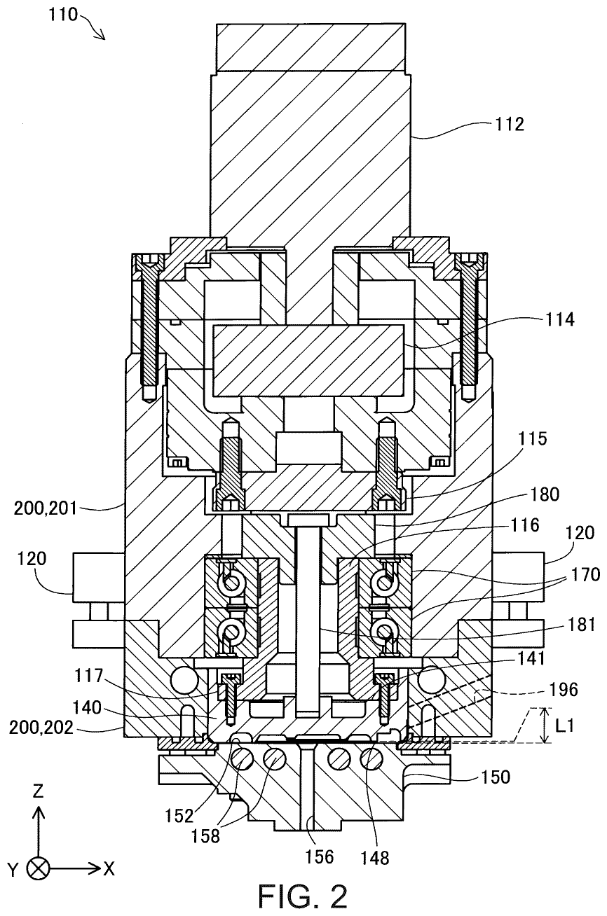

FIG. 2 is a cross-sectional view illustrating a schematic configuration of the plasticization section 110. The plasticization section 110 includes a drive motor 112, a decelerator 114, a screw shaft 116, a screw 140, a barrel 150, and a heating section 158. These are housed in or fixed to a housing 200. The housing 200 includes a first housing 201 and a second housing 202. The drive motor 112 and the decelerator 114 are attached to the upper portion of the first housing 201. The second housing 202 accommodates the screw 140. The barrel 150 is fixed to the lower side of the second housing 202.

The drive motor 112 is a motor for rotating the screw 140. The drive motor 112 is controlled by the control section 30.

The decelerator 114 is a device that reduces the rotational speed of the output shaft of the drive motor 112 according to a predetermined speed reduction ratio and outputs the reduced rotational speed. As the decelerator 114, for example, a planetary gear decelerator or a wave gear decelerator is used.

The screw shaft 116 is connected to the upper surface of the screw 140. A surface of the screw 140 to which the screw shaft 116 is connected is referred to as a connection surface 141. The screw shaft 116 is rotated by the drive motor 112. More specifically, the screw shaft 116 is rotated by the drive motor 112 via the decelerator 114 connected to the drive motor 112. A bearing 170 is provided on the outer periphery of the screw shaft 116. The bearing 170 is disposed in the first housing 201 and rotatably supports the screw shaft 116 with respect to the first housing 201.

The output shaft 115 of the decelerator 114 and the screw shaft 116 are connected via a connecting section 180 constituting a coupling. The screw shaft 116 has a cylindrical shape having a space therein. A flange section 117 is provided at a lower end of the screw shaft 116. The screw shaft 116 and the screw 140 are coupled by a bolt that passes through the flange section 117. The connecting section 180, the screw shaft 116, and the screw 140 are integrally connected by a connecting bolt 181 that passes through the centers of these components. The screw 140 has a groove forming surface 148 in which a groove is formed on a surface opposite to the connection surface 141, that is, on a lower surface.

A barrel 150 is disposed below the screw 140. A communication hole 156 communicating with the nozzle 104 is formed in the barrel 150. The barrel 150 has a facing surface 152 that faces the groove forming surface 148 of the screw 140. The groove forming surface 148 and the facing surface 152 are separated from each other by a distance L1.

The distance L1 between the groove forming surface 148 and the facing surface 152 can be adjusted by a position change mechanism 120 that changes the relative position between the screw 140 and the barrel 150. The position change mechanism 120 moves the first housing 201 relative to the second housing 202 in the +Z direction to lift the screw 140 relative to the barrel 150, thereby adjusting the distance L1 between the groove forming surface 148 and the facing surface 152. The position change mechanism 120 is configured by, for example, a linear actuator driven by hydraulic pressure or a motor. The position change mechanism 120 is controlled by the control section 30. The control section 30 can adjust the distance L1, for example, between 30 μm and 500 μm by controlling the position change mechanism 120.

A heating section 158 is embedded in the barrel 150. The heating section 158 is configured by, for example, a rod-shaped heater or an annular heater. The heating section 158 heats the material supplied between the screw 140 and the barrel 150. The heating by the heating section 158 is controlled by the control section 30.

The second housing 202 is provided with a material supply path 196 for supplying a material between the screw 140 and the barrel 150. The material supply path 196 is connected to the material storage section 102 shown in FIG. 1. The material is supplied from the material storage section 102 through the material supply path 196 between the screw 140 and the barrel 150.

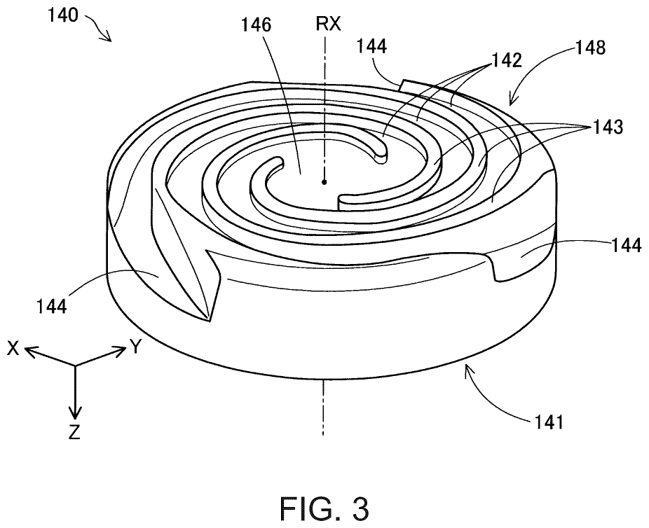

FIG. 3 is a perspective view showing a schematic configuration of the screw 140. In FIG. 3, the screw 140 is shown upside down. In FIG. 3, the position of the central axis RX of the screw 140 is shown by a dashed-dotted line. The screw 140 has a substantially cylindrical shape in which the height in the direction along the central axis RX is smaller than the diameter. The screw 140 has a groove forming surface 148 facing the facing surface 152 of the barrel 150. The groove forming surface 148 is provided with a groove section 142. The central section 146 of the groove forming surface 148 is configured as a recess to which one end of the groove section 142 is connected. The central section 146 faces the communication hole 156 of the barrel 150 shown in FIG. 2.

The groove section 142 of the screw 140 constitutes a so-called scroll groove. The groove section 142 extends in an arc-like spiral shape from the central section 146 toward the outer periphery of the screw 140. The groove section 142 may be configured to extend in an involute curve shape or a spiral shape. The groove forming surface 148 is provided with a protruding stripe section 143 that constitutes a side wall section of the groove section 142 and extends along each groove section 142. The groove section 142 is continuous to a material inlet 144 formed on the side surface of the screw 140. The material inlet 144 is a portion that receives the material supplied via the material supply path 196.

FIG. 3 shows an example of the screw 140 having three groove sections 142 and three protruding stripe sections 143. The number of the groove sections 142 and the number of the protruding stripe sections 143 provided in the screw 140 are not limited to three, and only one groove section 142 may be provided, or two or more groove sections 142 may be provided. In addition, FIG. 3 shows an example of the screw 140 in which the material inlets 144 are formed at three locations. The number of the material inlets 144 provided in the screw 140 is not limited to three, and may be provided only at one position, or may be provided at a plurality of positions of two or more positions. The screw 140 is also referred to as a flat screw or a rotor.

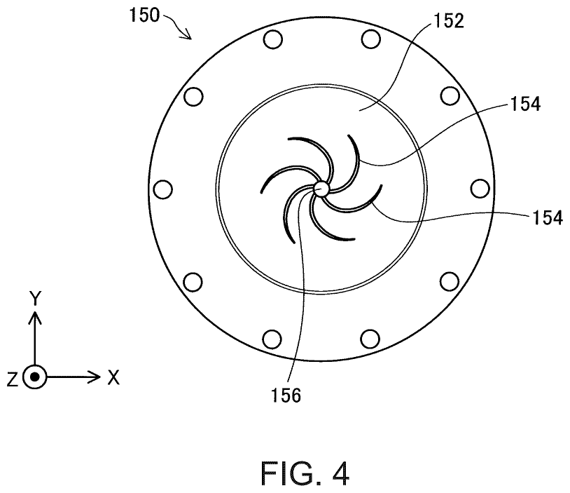

FIG. 4 is a top view of the barrel 150. The barrel 150 has the facing surface 152 that faces the groove forming surface 148 of the screw 140. A communication hole 156 communicating with the nozzle 104 is formed in the center of the facing surface 152.

A plurality of guide grooves 154 are formed around the communication hole 156 in the facing surface 152. Each of the guide grooves 154 has one end connected to the communication hole 156 and extends in a spiral shape from the communication hole 156 toward the outer periphery of the facing surface 152. Each of the guide grooves 154 has a function of guiding the molding material to the communication hole 156. One end of the guide groove 154 may not be connected to the communication hole 156. The guide groove 154 may not be formed in the barrel 150.

The material supplied into the groove section 142 of the screw 140 flows along the groove section 142 by rotation of the screw 140 while being melted in the groove section 142, and is guided to the central section 146 of the screw 140 as the molding material. The paste-like molding material exhibiting fluidity flowing into the central section 146 flows into the nozzle 104 via the communication hole 156 provided at the center of the barrel 150 and is ejected from the nozzle 104 toward the stage 220. In the molding material, all kinds of substances constituting the molding material may not be melted. The molding material may be converted into a state having fluidity as a whole by melting at least some kinds of substances among substances constituting the molding material. The molding material is also referred to as a plasticized material.

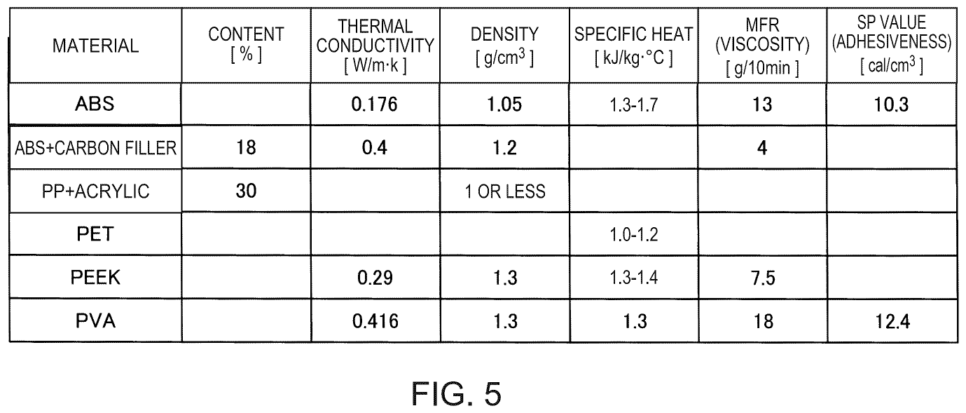

FIG. 5 is a diagram illustrating an example of a material used in molding of a three dimensional molded object. The three dimensional molding device 10 of the present embodiment uses, for example, acrylonitrile butadiene styrene (ABS), ABS containing a carbon filler, polypropylene (PP) containing acryl, polybutylene terephthalate (PET), polyether ether ketone (PEEK), or polyvinyl alcohol (PVA) as a material. PP with acrylic is an example of a bioplastic. FIG. 5 shows the thermal conductivity, density, specific heat, melt flow rate (MFR), and solubility parameter (SP value) of each material. In FIG. 5, the content of the carbon filler is shown for the ABS containing the carbon filler, and the content of the acrylic resin is shown for the PP containing the acrylic resin. MFR is an index indicating the flowability, that is, the viscosity of a material. A smaller value indicates that the material is less likely to flow and has a higher viscosity. The unit of MFR (g/10 min) indicates the mass of the plasticized material that flows in 10 minutes. MFR is measured, for example, by a melt flow rate tester. The SP value is a physical property value defined by the square root of cohesive energy density, and is a numerical value indicating the dissolution behavior of a solvent. In the present embodiment, the SP value is used as an index indicating the adhesiveness of the material. The closer the SP value is to the SP value of water (23.4), the higher the wettability and the higher the adhesiveness.

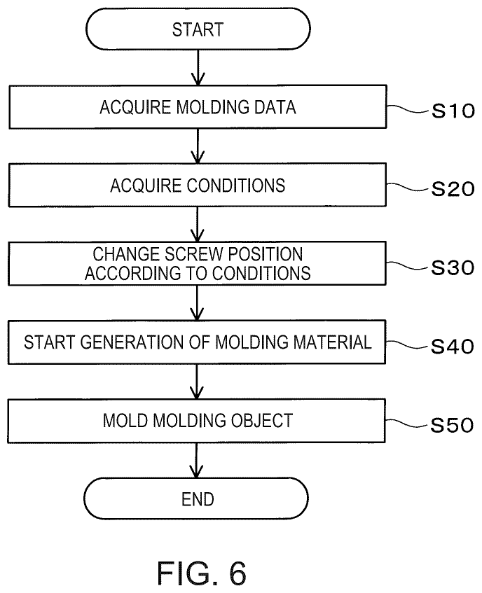

FIG. 6 is a flowchart of the three dimensional molding process executed by the control section 30. In step S10, the control section 30 acquires the molding data. The control section 30 acquires the molding data from, for example, a storage device or a recording medium provided in the control section 30, or a computer communicably connected to the control section 30. The movement path of the nozzle 104 and the ejection amount of the molding material in each movement path are recorded in the molding data.

In step S20, the control section 30 acquires conditions related to molding. In the present embodiment, the conditions related to molding are recorded in the molding data. Therefore, the control section 30 acquires the conditions related to molding from the molding data. The conditions related to molding are conditions that affect the molding quality and the molding speed of the three dimensional molded object. The condition related to molding includes, for example, at least one of (1) a condition related to molding accuracy, (2) a condition related to a molding speed, (3) a condition related to viscosity of the molding material, (4) a condition related to adhesiveness of the molding material, (5) a condition related to thermal conductivity of the molding material, (6) a condition related to density of the molding material, (7) a condition related to specific heat of the molding material, and (8) a condition related to size of the material. The control section 30 may receive the conditions related to molding from the user through a predetermined input interface connected to the control section 30.

In step S30, the control section 30 changes the relative position between the screw 140 and the barrel 150 according to the condition acquired in step S20. When the condition related to molding is the first condition, the control section 30 sets the distance between the screw 140 and the barrel 150 to a first distance. When the condition related to molding is the second condition, the control section 30 sets the distance between the screw 140 and the barrel 150 to a second distance, which is larger than the first distance. In the first embodiment, the condition related to molding is a condition related to molding accuracy, and the second condition is a condition in which the molding accuracy is higher than that of the first condition. Therefore, in the present embodiment, the higher the molding accuracy, the larger the distance between the screw 140 and the barrel 150.

In step S40, the control section 30 controls the plasticization section 110 to start generation of the molding material. The step of generating the molding material is referred to as a generation step. In the generation step, the molding material is generated after the distance between the screw 140 and the barrel 150 are adjusted in the step S30.

In step S50, the control section 30 controls the movement mechanism section 210 to move the nozzle 104 according to the movement path included in the molding date, and ejects the molding material from the nozzle 104 according to the ejection amount included in the molding data, thereby molding the three dimensional molded object on the stage 220. The step S50 is also referred to as a molding step.

As described above, in the first embodiment, since the distance between the screw 140 and the barrel 150 can be changed according to the conditions related to molding, at least one of the high accuracy and the high speed can be improved in the molding of the three dimensional molded object. In particular, in the present embodiment, the condition related to molding is a condition related to molding accuracy, and the higher the molding accuracy condition is, the more that the control section 30 increases the distance between the screw 140 and the barrel 150. In this manner, when the distance between the screw 140 and the barrel 150 is increased, the pressure of the molding material generated in plasticization section 110 is reduced, and the ejection speed of the molding material from the nozzle 104 is reduced. Therefore, the three dimensional molded object can be molded with high accuracy.

When the distance between the screw 140 and the barrel 150 increases, basically, the internal pressure decreases, and the ejection amount of the molding material decreases. While the distance between the screw 140 and the barrel 150 is large, in order to eject the molding material at the same flow rate as that in a state where the distance between the screw 140 and the barrel 150 is small, the rotation speed of the screw 140 need only be increased. When the rotation speed of the screw 140 is increased, the influence of temperature unevenness of the barrel 150 during the plasticization of the material is reduced, and plasticization unevenness is also reduced. Therefore, the line width of the molding material ejected from the nozzle 104 can be stabilized by increasing the distance between the screw 140 and the barrel 150 and increasing the rotation speed of the screw 140 rather than by decreasing the distance between the screw 140 and the barrel 150. In addition, when the distance between the screw 140 and the barrel 150 is increased, the resistance of the material is reduced, and thus the screw 140 can be easily rotated even when the torque of the drive motor 112 is small. Therefore, if the distance between the screw 140 and the barrel 150 is increased, the possibility that the drive motor 112 is overloaded and stopped due to the resistance of the material can be reduced.

### B. Second Embodiment

The configuration of the three dimensional molding device 10 in the second embodiment is the same as that in the first embodiment. In the second embodiment, in step S20 of the three dimensional molding process shown in FIG. 6, the control section 30 acquires a condition related to molding speed as the condition related to molding.

In step S30, when the condition related to the molding speed is the first condition, the control section 30 sets the distance between the screw 140 and the barrel 150 to the first distance. When the condition related to the molding speed is the second condition, the control section 30 sets the distance between the screw 140 and the barrel 150 to the second distance, which is larger than the first distance. In the present embodiment, the second condition is a condition in which the molding speed is higher than that in the first condition. Therefore, in the present embodiment, the higher the molding speed, the smaller the distance between the screw 140 and the barrel 150.

As described above, in the second embodiment, the control section 30 decreases the distance between the screw 140 and the barrel 150 as the molding speed increases. In this manner, when the distance between the screw 140 and the barrel 150 is reduced, the pressure of the molding material generated in the plasticization section 110 increases, and the ejection speed of the molding material from the nozzle 104 increases. Therefore, the three dimensional molded object can be molded at high speed.

Note that although the speed of molding can be increased by increasing the rotation speed of the screw 140, the rotation speed of the screw 140 is limited, so molding can be performed at a higher speed by reducing the distance between the screw 140 and the barrel 150.

### C. Third Embodiment

The configuration of the three dimensional molding device 10 in the third embodiment is the same as that in the first embodiment. In the third embodiment, in step S20 of the three dimensional molding process shown in FIG. 6, the control section 30 acquires a condition related to the viscosity of the molding material as the condition related to molding. For example, the control section 30 stores, in the storage device, the table shown in FIG. 5, which indicates the characteristics of each material, and receives selection of the type of molding material used for molding from the molding data or the user. Then, the control section 30 acquires the viscosity of the molding material corresponding to the selected type from the table stored in the storage device.

In step S30, when the condition related to the viscosity of the molding material is the first condition, the control section 30 sets the distance between the screw 140 and the barrel 150 to the first distance. When the condition related to the viscosity of the molding material is the second condition, the control section 30 sets the distance between the screw 140 and the barrel 150 to the second distance, which is larger than the first distance. In the present embodiment, the second condition is a condition in which the viscosity of the molding material is higher than that in the first condition. Therefore, in the present embodiment, the higher the viscosity of the molding material, the larger the distance between the screw 140 and the barrel 150. In the example of the material shown in FIG. 5, the MFR value of ABS containing carbon filler is the smallest, and thus the viscosity is the highest, and the MFR value of PVA is the largest, and thus the viscosity is the lowest. Therefore, when ABS containing a carbon filler is used as the molding material, the distance between the screw 140 and the barrel 150 is the largest, and when PVA is used as the molding material, the distance between the screw 140 and the barrel 150 is the smallest.

As described above, in the third embodiment, the control section 30 increases the distance between the screw 140 and the barrel 150 as the viscosity of the molding material increases. When the distance between the screw 140 and the barrel 150 is small, if a molding material having a high viscosity is used, the molding material may adhere to the screw 140 and the barrel 150, and the fluidity may deteriorate. In contrast, when the distance between the screw 140 and the barrel 150 is increased, even when the viscosity of the molding material is high, the fluidity can be increased, and thus, molding can be stably performed. In addition, when the distance between the screw 140 and the barrel 150 is increased, it is possible to suppress the rotation of the drive motor 112 from being hindered by the molding material having a high viscosity, and thus it is possible to suppress the motor from being in an overload state.

### D. Fourth Embodiment

The configuration of the three dimensional molding device 10 in the fourth embodiment is the same as that in the first embodiment. In the fourth embodiment, in step S20 of the three dimensional molding process shown in FIG. 6, the control section 30 acquires a condition related to the adhesiveness of the molding material as the condition related to molding. For example, the control section 30 stores, in the storage device, the table shown in FIG. 5, which indicates the characteristics of each material, and receives selection of the type of molding material used for molding from the molding data or the user. Then, the control section 30 acquires the adhesiveness of the molding material corresponding to the selected type from the table stored in the storage device.

In step S30, when the condition related to the adhesiveness of the molding material is the first condition, the control section 30 sets the distance between the screw 140 and the barrel 150 to the first distance. When the condition related to the adhesiveness of the molding material is the second condition, the control section 30 sets the distance between the screw 140 and the barrel 150 to the second distance, which is larger than the first distance. In the present embodiment, the second condition is a condition in which the adhesiveness of the molding material is higher than that in the first condition. Therefore, in the present embodiment, the higher the adhesiveness of the molding material, the larger the distance between the screw 140 and the barrel 150. In the example of the material shown in FIG. 5, the SP value of PVA is closer to the SP value of water (23.4) than the SP value of ABS, and therefore, PVA has higher adhesiveness. Therefore, when PVA is used as the molding material, the distance between the screw 140 and the barrel 150 is larger than when ABS is used.

As described above, in the fourth embodiment, the higher the adhesiveness of the molding material, the more that the control section 30 increases the distance between the screw 140 and the barrel 150. When the distance between the screw 140 and the barrel 150 is small, if a molding material having high adhesiveness is used, the molding material may adhere to the screw 140 and the barrel 150, and the fluidity may deteriorate. In contrast, when the distance between the screw 140 and the barrel 150 is increased, even when the adhesiveness of the molding material is high, the fluidity can be increased, and thus, the molding can be stably performed. In addition, when the distance between the screw 140 and the barrel 150 is increased, it is possible to suppress the rotation of the drive motor 112 from being hindered by the molding material having high adhesiveness, and thus, it is possible to suppress the drive motor 112 from being in an overload state.

### E. Fifth Embodiment

The configuration of the three dimensional molding device 10 in the fifth embodiment is the same as that in the first embodiment. In the fifth embodiment, in step S20 of the three dimensional molding process shown in FIG. 6, the control section 30 acquires a condition related to the heat conductivity of the molding material as the condition related to molding. For example, the control section 30 stores, in the storage device, the table shown in FIG. 5, which indicates the characteristics of each material, and receives selection of the type of molding material used for molding from the molding data or the user. Then, the control section 30 acquires the thermal conductivity of the molding material corresponding to the selected type from the table stored in the storage device.

In step S30, when the condition related to the thermal conductivities of the molding materials is the first condition, the control section 30 sets the distance between the screw 140 and the barrel 150 to the first distance. When the condition related to the thermal conductivity of the molding material is the second condition, the control section 30 sets the distance between the screw 140 and the barrel 150 to the second distance, which is larger than the first distance. In the present embodiment, the second condition n is a condition in which the thermal conductivity of the molding material is higher than that in the first condition. Therefore, in the present embodiment, the higher the thermal conductivity of the molding material, the larger the distance between the screw 140 and the barrel 150. In the example of materials shown in FIG. 5, PVA has the highest thermal conductivity and ABS has the lowest thermal conductivity. Therefore, when PVA is used as the molding material, the distance between the screw 140 and the barrel 150 is the largest, and when ABS is used, the distance between the screw 140 and the barrel 150 is the smallest.

As described above, in the fifth embodiment, the higher the thermal conductivity of the molding material, the more that the control section 30 increases the distance between the screw 140 and the barrel 150. In order to improve the transportability of the material when the material is plasticized, the screw 140 preferably has a low temperature. This is because when the screw 140 is at a high temperature, the material is plasticized early, and the transportability by the rotation of the screw 140 is lowered. Therefore, as in the present embodiment, when the thermal conductivity of the material is high, if the distance between the screw 140 and the barrel 150 is increased, it is possible to suppress the conduction of heat from the barrel 150 side to the screw 140 side through the material, and thus it is possible to suppress the screw 140 from becoming hot. Therefore, when the distance between the screw 140 and the barrel 150 is increased, the molding material can be stably generated even when the thermal conductivity of the material is high.

### F. Sixth Embodiment

The configuration of the three dimensional molding device 10 in the sixth embodiment is the same as that in the first embodiment. In the sixth embodiment, in step S20 of the three dimensional molding process shown in FIG. 6, the control section 30 acquires a condition related to the density of the molding material as the condition related to molding. For example, the control section 30 stores, in the storage device, the table shown in FIG. 5, which indicates the characteristics of each material, and receives selection of the type of molding material used for molding from the molding data or the user. Then, the control section 30 acquires the density of the molding material corresponding to the selected type from the table stored in the storage device.

In step S30, when the condition related to the density of the molding materials is the first condition, the control section 30 sets the distance between the screw 140 and the barrel 150 to the first distance. When the condition related to the density of the molding material is the second condition, the control section 30 sets the distance between the screw 140 and the barrel 150 to the second distance, which is larger than the first distance. In the present embodiment, the second condition is a condition in which the density of the molding material is lower than that in the first condition. Therefore, in the present embodiment, the lower the density of the molding material, the larger the distance between the screw 140 and the barrel 150. In the example of the material shown in FIG. 5, the density of PP containing acrylic is the lowest, and the densities of PEEK and PVA are the highest. Therefore, when PP containing acrylic is used as the molding material, the distance between the screw 140 and the barrel 150 is the largest, and when PEEK or PVA is used, the distance between the screw 140 and the barrel 150 is the smallest.

As described above, in the sixth embodiment, the lower the density of the molding material, the more that the control section 30 increases the distance between the screw 140 and the barrel 150. Bioplastic materials such as PP containing acrylic are low in density and are difficult to melt. Therefore, by increasing the distance between the screw 140 and the barrel 150 and decreasing the transporting speed of the material between the screw 140 and the barrel 150 the lower that density of the material is, then the time for heat to be transferred from the barrel 150 to the material increases, and the plasticization of the material can be promoted. Therefore, when the distance between the screw 140 and the barrel 150 is increased, the molding material can be stably generated even when a material having a low density and being hard to dissolved is used.

### G. Seventh Embodiment

The configuration of the three dimensional molding device 10 in the seventh embodiment is the same as that in the first embodiment. In the seventh embodiment, in step S20 of the three dimensional molding process shown in FIG. 6, the control section 30 acquires a condition related to specific heat of the molding material as a condition related to molding. For example, the control section 30 stores, in the storage device, the table shown in FIG. 5, which indicates the characteristics of each material, and receives selection of the type of molding material used for molding from the molding data or the user. Then, the control section 30 acquires the specific heat of the molding material corresponding to the selected type from the table stored in the storage device.

In step S30, when the condition related to the specific heat of the molding material is the first condition, the control section 30 sets the distance between the screw 140 and the barrel 150 to the first distance. When the condition related to the specific heat of the molding material is the second condition, the control section 30 sets the distance between the screw 140 and the barrel 150 to the second distance, which is larger than the first distance. In the present embodiment, the second condition is a condition in which the specific heat of the molding material is smaller than that in the first condition. Therefore, in the present embodiment, the smaller the specific heat of the molding material, the larger the distance between the screw 140 and the barrel 150. In the example of the materials shown in FIG. 5, the specific heat of PET is the smallest, and the specific heat of ABS is the largest. Therefore, when PET is used as the molding material, the distance between the screw 140 and the barrel 150 is the largest, and when ABS is used, the distance between the screw 140 and the barrel 150 is the smallest.

As described above, in the seventh embodiment, the smaller specific heat of the molding material is, the more that the control section 30 increases the distance between the screw 140 and the barrel 150. In order to satisfactorily transport the material when the material is plasticized, it is preferable that the shape of the material is maintained to some extent between the screw 140 and the barrel 150. However, when the specific heat of the material is small, the material is likely to melt, and thus there is a possibility that the transportation of the material between the screw 140 and the barrel 150 is delayed. Therefore, when the specific heat of the material is small, if the distance between the screw 140 and the barrel 150 is increased, the shape of the material is maintained, and thus, easily the transportability of the material can be enhanced, and the three dimensional molded object can be stably molded.

### H. Eighth Embodiment

The configuration of the three dimensional molding device 10 in the eighth embodiment is the same as that in the first embodiment. In the eighth embodiment, in step S20 of the three dimensional molding process shown in FIG. 6, the control section 30 acquires a condition related to the size of the material as a condition related to molding. For example, the control section 30 stores a table indicating characteristics of each material in a storage device, and receives selection of a type of molding material used for molding from molding data or a user. Then, the control section 30 acquires the size of the molding material corresponding to the selected type from the table stored in the storage device.

In step S30, when the condition related to the size of the material is the first condition, the control section 30 sets the distance between the screw 140 and the barrel 150 to the first distance. When the condition related to the size of the material is the second condition, the control section 30 sets the distance between the screw 140 and the barrel 150 to the second distance, which is larger than the first distance. In the present embodiment, the second condition is a condition in which the size of the material is larger than that in the first condition. Therefore, in the present embodiment, the larger the size of the material, the larger the distance between the screw 140 and the barrel 150. As described above, in the eighth embodiment, the control section 30 increases the distance between the screw 140 and the barrel 150 as the size of the material increases. In this way, when a material having a large size is used, the material is easily taken in between the screw 140 and the barrel 150 from the material supply path 196 through the material inlet 144. Therefore, when the distance between the screw 140 and the barrel 150 is increased, the molding material can be stably generated even when a large material is used.

### I. Other Aspects

The present disclosure is not limited to the above described embodiments, and can be realized in various configurations without departing from the spirit thereof. For example, the technical features of the embodiments corresponding to the technical features in each aspect described below can be appropriately replaced or combined in order to solve a part or all of the problems described above or to achieve a part or all of the effects described above. Unless the technical features are described as essential in the present specification, the technical features can be appropriately deleted.
(1) According to a first aspect of the present disclosure, a three dimensional molding device is provided. This three dimensional molding device includes a plasticization section that plasticizes a material to generate a molding material; a nozzle that ejects the molding material toward a stage; and a control section that controls molding of a three dimensional molded object by ejecting the molding material from the nozzle, wherein the plasticization section includes a drive motor, a screw that is rotated by the drive motor and that has a groove forming surface in which a protruding stripe section is formed from a central section toward an outer periphery, a barrel that faces the groove forming surface and that has a communicating hole communicating with the nozzle at a position facing the central section of the groove forming surface, a heating section configured to heat the material supplied between the screw and the barrel, and a position change mechanism configured to change a relative position between the screw and the barrel, the control section when a condition related to molding is a first condition, sets a distance between the screw and the barrel to a first distance by using the position change mechanism and causes the plasticization section to generate the molding material and when the condition is a second condition, sets the distance between the screw and the barrel to a second distance by using the position change mechanism and causes the plasticization section to generate the molding material, and the second distance is greater than the first distance.

According to such an aspect, since the distance between the screw and the barrel can be changed according to the condition related to molding, at least one of high accuracy and high speed can be improved in the molding of the three dimensional molded object.
(2) The above aspect may be such that the condition related to molding is a condition related to molding accuracy and the second condition is a higher molding accuracy than the first condition.

According to such an aspect, in a case where the molding accuracy is increased, the pressure of the molding material can be reduced by increasing the distance between the screw and the barrel. Therefore, the ejection speed of the molding material is reduced, and the three dimensional molded object can be molded with high accuracy.
(3) The above aspect may be such that the condition related to molding is a condition related to a molding speed and the first condition is a higher molding speed than the second condition.

According to such an aspect, in a case where the molding speed is increased, the pressure of the molding material can be increased by reducing the distance between the screw and the barrel. Therefore, the ejection speed of the molding material is increased, and the three dimensional molded object can be molded with high speed.
(4) The above aspect may be such that the condition related to molding is a condition related to a viscosity of the molding material and the second condition is a higher viscosity of the molding material than the first condition.

According to such an aspect, even when a molding material having a high viscosity is used, the distance between the screw and the barrel is increased, and thus, the fluidity of the molding material in the plasticization section can be improved, and the three dimensional molded object can be stably molded.
(5) The above aspect may be such that the condition related to molding is a condition related to adhesiveness of the molding material and the second condition is a higher adhesiveness of the molding material than the first condition.

According to such an aspect, even when a molding material having high adhesiveness is used, the distance between the screw and the barrel is increased, and thus, the fluidity of the molding material in the plasticization section can be improved, and the three dimensional molded object can be stably molded.
(6) The above aspect may be such that the condition related to molding is a condition related to thermal conductivity of the molding material and the second condition is a higher thermal conductivity of the molding material than the first condition.

According to such an aspect, even when a molding material having a high thermal conductivity is used, the distance between the screw and the barrel is increased, and thus, the transfer of heat from the barrel to the screw is suppressed, and the three dimensional molded object can be stably molded.
(7) The above aspect may be such that the condition related to molding is a condition related to density of the molding material and the second condition is a lower density of the molding material than the first condition.

According to such an aspect, in a case where the density of the molding material is low, the distance between the screw and the barrel is increased, and thus, the transport speed of the molding material can be decreased, and accordingly, the time for heating the molding material is increased, and the molding material having a low density can be easily plasticized. Therefore, even when a molding material that has a low density and that is difficult to be plasticized is used, the three dimensional molded object can be stably molded.
(8) The above aspect may be such that the condition related to molding is a condition related to specific heat of the molding material and the second condition may be smaller in specific heat of the molding material than in the first condition.

According to such an aspect, even when a molding material having a small specific heat and being easily melted is used, the shape of the molding material is easily maintained by increasing the distance between the screw and the barrel, and the molding material can be smoothly transported between the screw and the barrel. Therefore, the three dimensional molded object can be stably molded.
(9) The above aspect may be such that the condition related to molding is a condition related to size of the material and the second condition is a larger size of the material than the first condition.

According to such an aspect, even when a large sized molding material is used, the material is easily taken in between the screw and the barrel by increasing the distance between the screw and the barrel. Therefore, the three dimensional molded object can be stably molded.
(10) According to a second aspect of the present disclosure, there is provided a method for manufacturing a three dimensional object. This manufacturing method includes a generation step of generating a molding material by plasticizing a material by a plasticization section and a molding step of molding a three dimensional molded object by ejecting the molding material from a nozzle, wherein the plasticization section includes a drive motor, a screw that is rotated by the drive motor and that has a groove forming surface in which a protruding stripe section is formed from a central section toward an outer periphery, a barrel that faces the groove forming surface and that has a communicating hole communicating with the nozzle at a position facing the central section of the groove forming surface, a heating section configured to heat the material supplied between the screw and the barrel, and a position change mechanism configured to change a relative position between the screw and the barrel, in the generation step when a condition related to molding is a first condition, sets a distance between the screw and the barrel to a first distance by using the position change mechanism and causes the plasticization section to generate the molding material and when the condition is a second condition, sets the distance between the screw and the barrel to a second distance by using the position change mechanism and causes the plasticization section to generate the molding material, and the second distance is greater than the first distance.

What is claimed is:

1. A three dimensional molding device comprising:
a plasticization section that plasticizes a material to generate a molding material;
a nozzle that ejects the molding material toward a stage; and
a control section that controls molding of a three dimensional molded object by ejecting the molding material from the nozzle, wherein
the plasticization section includes
a drive motor,
a screw that is rotated by the drive motor and that has a groove forming surface in which a protruding stripe section is formed from a central section toward an outer periphery,
a barrel that faces the groove forming surface and that has a communicating hole communicating with the nozzle at a position facing the central section of the groove forming surface,
a heating section configured to heat the material supplied between the screw and the barrel, and
a position change mechanism configured to change
a relative position between the screw and the barrel, the control section
when a condition related to molding is a first condition, sets a distance between the screw and the barrel to a first distance by using the position change mechanism and causes the plasticization section to generate the molding material and
when the condition is a second condition, sets the distance between the screw and the barrel to a second distance by using the position change mechanism and causes the plasticization section to generate the molding material, and
the second distance is greater than the first distance.

2. The three dimensional molding device according to claim 1, wherein
the condition related to molding is a condition related to molding accuracy and
the second condition is a higher molding accuracy than the first condition.

3. The three dimensional molding device according to claim 1, wherein
the condition related to molding is a condition related to a molding speed and
the first condition is a higher molding speed than the second condition.

4. The three dimensional molding device according to claim 1, wherein
the condition related to molding is a condition related to a viscosity of the molding material and
the second condition is a higher viscosity of the molding material than the first condition.

5. The three dimensional molding device according to claim 1, wherein
the condition related to molding is a condition related to adhesiveness of the molding material and
the second condition is a higher adhesiveness of the molding material than the first condition.

6. The three dimensional molding device according to claim 1, wherein
the condition related to molding is a condition related to thermal conductivity of the molding material and
the second condition is a higher thermal conductivity of the molding material than the first condition.

7. The three dimensional molding device according to claim 1, wherein
the condition related to molding is a condition related to density of the molding material and
the second condition is a lower density of the molding material than the first condition.

8. The three dimensional molding device according to claim 1, wherein
the condition related to molding is a condition related to specific heat of the molding material and
the second condition is a smaller specific heat of the molding material than the first condition.

9. The three dimensional molding device according to claim 1, wherein
the condition related to molding is a condition related to size of the material and
the second condition is a larger size of the material than the first condition.

10. A method for manufacturing a three dimensional molded object for molding comprising:
a generation step of generating a molding material by plasticizing a material by a plasticization section and
a molding step of molding a three dimensional molded object by ejecting the molding material from a nozzle, wherein
the plasticization section includes
a drive motor,
a screw that is rotated by the drive motor and that has a groove forming surface in which a protruding stripe section is formed from a central section toward an outer periphery,
a barrel that faces the groove forming surface and that has a communicating hole communicating with the nozzle at a position facing the central section of the groove forming surface,
a heating section configured to heat the material supplied between the screw and the barrel, and
a position change mechanism configured to change
a relative position between the screw and the barrel, in the generation step
when a condition related to molding is a first condition, sets a distance between the screw and the barrel to a first distance by using the position change mechanism and causes the plasticization section to generate the molding material and
when the condition is a second condition, sets the distance between the screw and the barrel to a second distance by using the position change mechanism and causes the plasticization section to generate the molding material, and
the second distance is greater than the first distance.
